(19) United States
(12) Patent Application Publication
(10) Pub. No.: US 2026/0018822 A1
(43) Pub. Date: Jan. 15, 2026

(54) Connector Shielding Shell, Connector and Connector Assembly

(71) Applicant: Tyco Electronics (Shanghai) Co., Ltd., Shanghai (CN)

(72) Inventors: Yongfeng (Richard) Ma, Shanghai (CN); WenYu (Vindy) Liu, Shanghai (CN); Guangming (Suny) Zhao, Shanghai (CN); Xinbo (Polly) Liu, Shanghai (CN)

(73) Assignee: Tyco Electronics (Shangahi) Co., Ltd., Shanghai (CN)

(21) Appl. No.: 19/265,657

(22) Filed: Jul. 10, 2025

(30) Foreign Application Priority Data
Jul. 10, 2024 (CN) 202410926192.2

(51) Int. Cl. H01R 13/50; H01R 12/71; H01R 13/516; H01R 13/627

(52) U.S. Cl. CPC H01R 13/50; H01R 12/712; H01R 13/516; H01R 13/6271

(57) ABSTRACT

A connector shielding shell includes a row of plug pins used to press fit into a row of holes in a circuit board to fix the connector shielding shell to the circuit board. A protruding support portion is formed on lower side edges of a pair of side walls and/or a bottom wall of the connector shielding shell. The support portion is located in front of the front most one in the row of plug pins and is spaced apart from the front most plug pin by a predetermined distance in the longitudinal direction. When a vertical downward external force is applied to a mating connector inserted into the front port of the connector shielding shell, the support portion is pressed against the circuit board as a fulcrum of the connector shielding shell on the circuit board, to increase the force arm and holding torque of each plug pin.

### CROSS-REFERENCE TO RELATED APPLICATION

This application claims the benefit of the filing date under 35 U.S.C. § 119(a)-(d) of Chinese Patent Application No. 202410926192.2, filed on Jul. 10, 2024.

### FIELD OF THE INVENTION

The present invention relates to a connector shielding shell, a connector comprising the connector shielding shell, and a connector assembly comprising the connector.

### BACKGROUND OF THE INVENTION

A shielding shell of a connector commonly includes a pair of side walls, a top wall, a bottom wall, and a rear end wall. A row of fish eye shaped plug pins are formed on the lower sides of the pair of side walls, which are used to press fit into holes in a circuit board to fix the shielding shell of the connector to the circuit board.

After inserting a mating connector into a front port of the connector, it is sometimes necessary to apply a vertical downward external force on the cable of the mating connector to bend the cable. When the applied external force exceeds a predetermined value, the shielding shell of the connector will tilt upwards with the front plug pin as the fulcrum, which will cause the plug pin to be pulled out of the hole of the circuit board.

### SUMMARY OF THE INVENTION

A connector shielding shell includes a row of plug pins used to press fit into a row of holes in a circuit board to fix the connector shielding shell to the circuit board. A protruding support portion is formed on lower side edges of a pair of side walls and/or a bottom wall of the connector shielding shell. The support portion is located in front of the front most one in the row of plug pins and is spaced apart from the front most plug pin by a predetermined distance in the longitudinal direction. When a vertical downward external force is applied to a mating connector inserted into the front port of the connector shielding shell, the support portion is pressed against the circuit board as a fulcrum of the connector shielding shell on the circuit board, to increase the force arm and holding torque of each plug pin.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector according to an exemplary embodiment of the present invention;

FIG. 2 shows a longitudinal sectional view of a connector according to an exemplary embodiment of the present invention;

FIG. 3 shows an illustrative perspective view of a connector shielding shell according to an exemplary embodiment of the present invention when viewed from the top;

FIG. 4 shows an illustrative perspective view of a connector shielding shell according to an exemplary embodiment of the present invention when viewed from the bottom;

FIG. 5 shows an illustrative exploded view of a connector shielding shell according to an exemplary embodiment of the present invention;

FIG. 6 shows an illustrative perspective view of a connector assembly according to an exemplary embodiment of the present invention;

FIG. 7 shows a side view of the connector assembly of the prior art;

FIG. 8 shows a side view of a connector assembly according to an exemplary embodiment of the present invention;

FIG. 9 shows an illustrative perspective view of a connector shielding shell according to another exemplary embodiment of the present invention when viewed from the bottom; and

FIG. 10 shows a side view of a connector assembly according to another exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

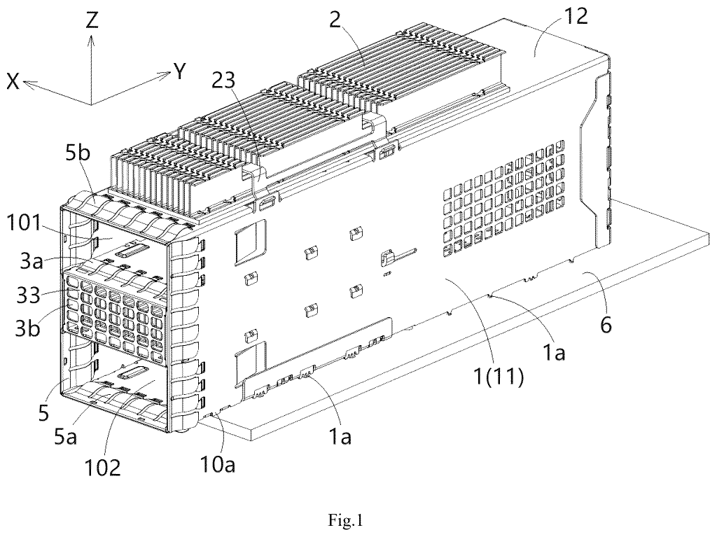

As shown in FIGS. 1-6 and 8-10, in an exemplary embodiment of the present invention, a connector shielding shell 1 is disclosed. The connector shielding shell 1 includes a front port and a rear end wall 14 that are opposite in its longitudinal direction Y, a pair of side walls 11 that are opposite in its transverse direction X, and a top wall 12 and a bottom wall 13 that are opposite in its height direction Z. A row of plug pins 1a are formed on the lower sides of the pair of side walls 11, which are used to press fit into a row of holes in the circuit board 6 to fix the connector shielding shell 1 to the circuit board 6.

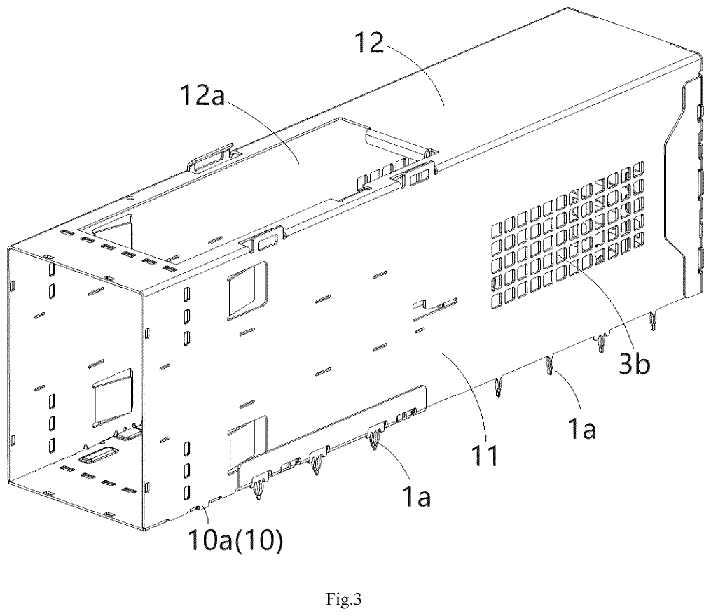

As shown in FIGS. 3, 4, and 8-10, in the illustrated embodiment, a protruding support portion 10 is formed on the lower side edges of a pair of side walls 11 and/or the bottom wall 13. The support portion 10 is located in front of the front most plug pin 1a in the row of plug pins 1a and is spaced apart from the front most plug pin 1a by a predetermined distance d in the longitudinal direction Y, as shown in FIG. 8. When a vertical downward external force F is applied to a mating connector 7 in the front port of the connector shielding shell 1, the support portion 10 is pressed against the circuit board 6, serving as a fulcrum for the connector shielding shell 1 on the circuit board 6, to increase the force arm Li′ and holding torque of each plug pin 1a.

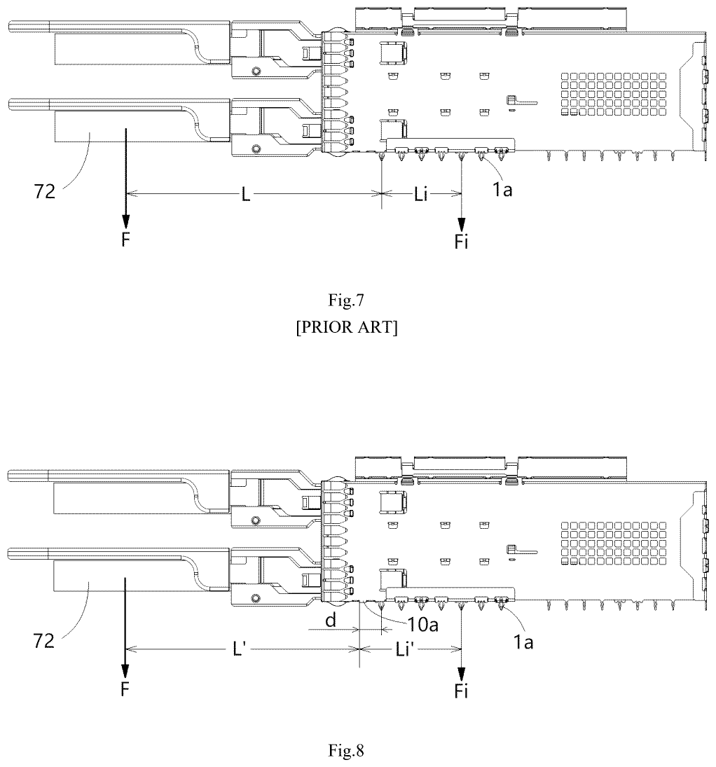

FIG. 7 shows a side view of the connector assembly of the prior art. As shown in FIG. 7, in the prior art, when bending the cable 72 of the mating connector 7, a vertical downward external force F is applied to the cable 72 of the mating connector 7. At this time, when the applied external force F exceeds the predetermined value, the connector shielding shell 1 will tilt upwards with the front plug pin 1a as the fulcrum, which will cause the plug pin 1a to be pulled out of the hole of the circuit board 6.

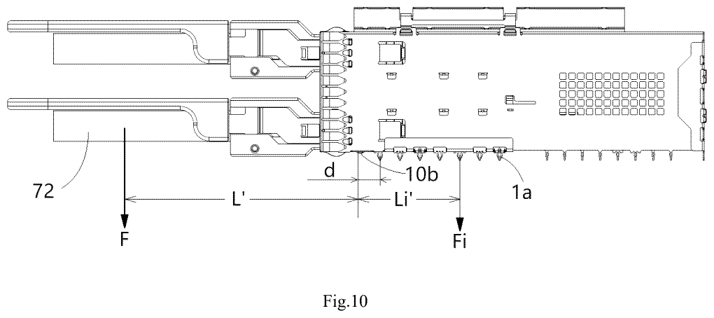

As shown in FIGS. 8 and 10, in the embodiments of the present invention, the fulcrum of the connector shielding shell 1 is moved forward by a predetermined distance d, so that the force arm Li′ of the plug pin 1a is increased by the aforementioned predetermined distance d compared to the force arm Li of the plug pin 1a in the prior art, shown in FIG. 7. In this way, the holding torque of the plug pin 1a can be increased by Fi*d, effectively preventing the plug pin 1a from being pulled out of the hole of the circuit board 6. In addition, in the aforementioned embodiments of the present invention, due to the forward movement of the fulcrum of the connector shielding shell 1 by a predetermined distance d, the force arm L′ of the external force F is reduced by the aforementioned predetermined distance d compared to the force arm L of the external force F in the prior art. In this way, the external torque can be reduced by F*d, effectively preventing the plug pin 1a from being pulled out of the hole of the circuit board 6.

As shown in FIGS. 3, 4, and 8-10, in the illustrated embodiment, the support portion 10 includes support legs 10a formed on the lower side edges of a pair of side walls 11. The support legs 10a are tongue shaped and their bottom is adapted to rest on the top surface of the circuit board 6.

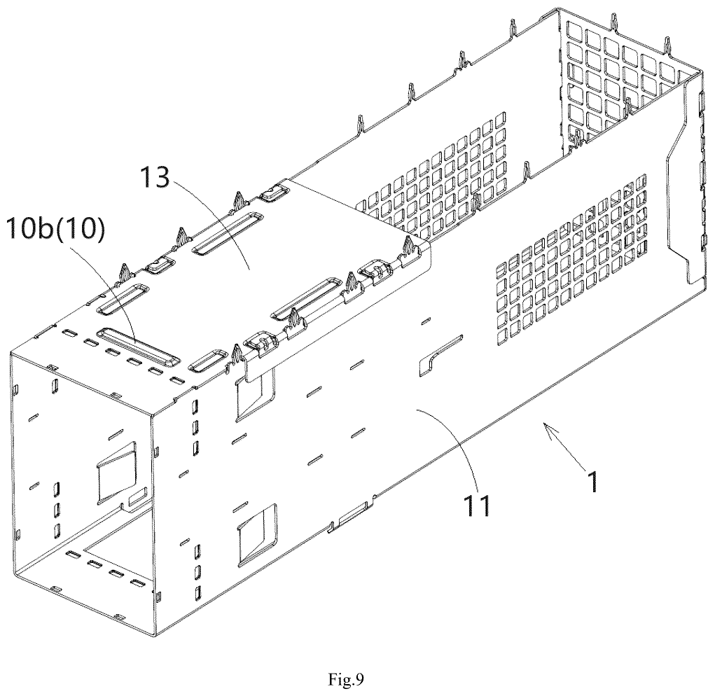

As shown in FIG. 9, in the illustrated embodiment, the support portion 10 includes a support rib 10b formed on the bottom surface of the bottom wall 13, which extends along the transverse direction X of the connector shielding shell 1 and is adapted to rest on the top surface of the circuit board 6.

When the connector shielding shell 1 is fixed to the circuit board 6, the bottom of the support portion 10 is pressed against the top surface of the circuit board 6.

As shown in FIGS. 1-5, in the illustrated embodiment, multiple plug pins 1a are formed on the lower side of the rear end wall 14, and the multiple plug pins 1a on the rear end wall 14 are arranged in a row along the transverse direction X of the connector shielding shell 1, for respectively press fitting into multiple holes in the circuit board 6.

As shown in FIGS. 1, 3, and 5, in the illustrated embodiment, multiple heat dissipation holes 3b are formed in the rear portions of the pair of side wall 11 and the rear end wall 14, respectively, to connect the internal space of the connector shielding shell 1 with the external atmosphere and improve the ventilation and heat dissipation performance of the connector shielding shell 1.

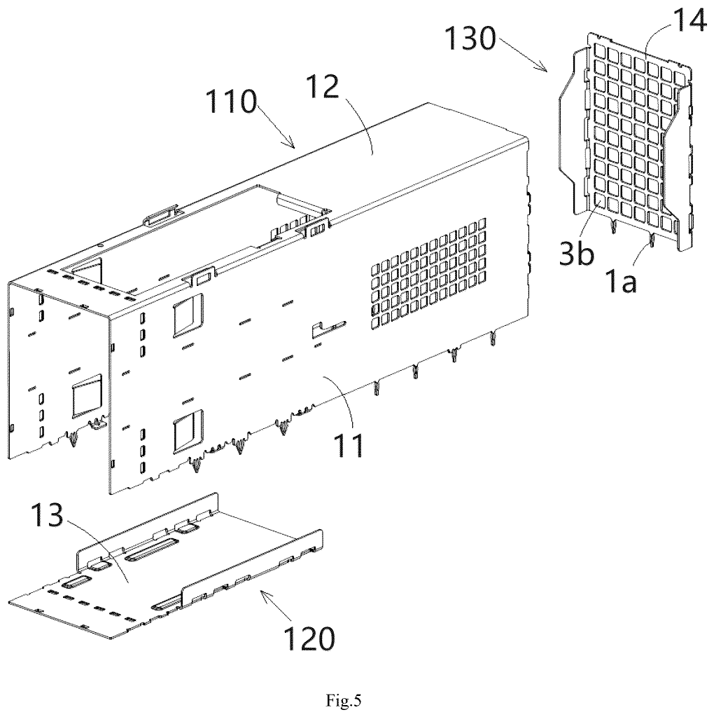

As shown in FIGS. 5, in the illustrated embodiment, the connector shielding shell 1 includes a main shell portion 110, a bottom shell portion 120, and a rear shell portion 130. The main shell portion 110 is used to define a pair of side walls 11 and a top wall 12 of the connector shielding shell 1. The bottom shell portion 120 is assembled onto the bottom of a pair of side walls 11 to define the bottom wall 13 of the connector shielding shell 1. The rear shell portion 130 is assembled onto the rear end of a pair of side walls 11 to define the rear end wall 14 of the connector shielding shell 1. Each of the main shell portion 110, the bottom shell portion 120, and the rear shell portion 130 is an integral stamped part in the shown embodiment.

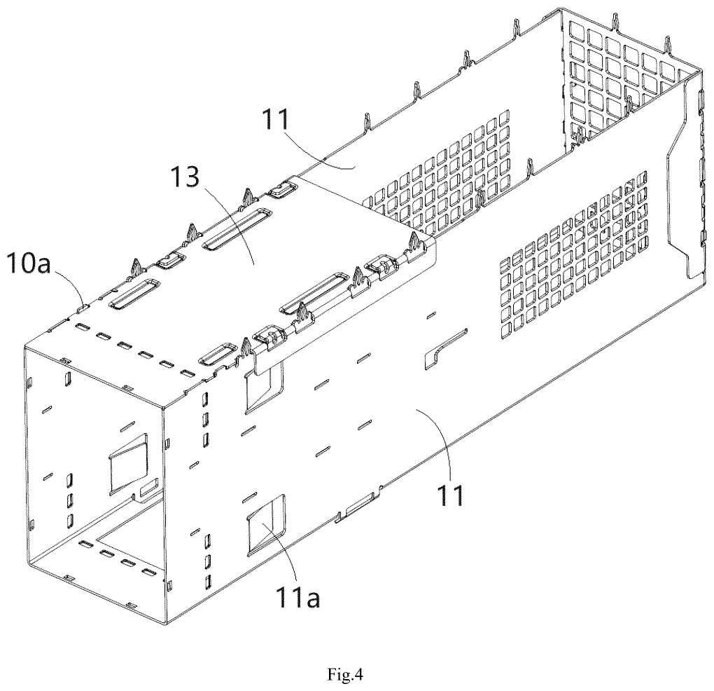

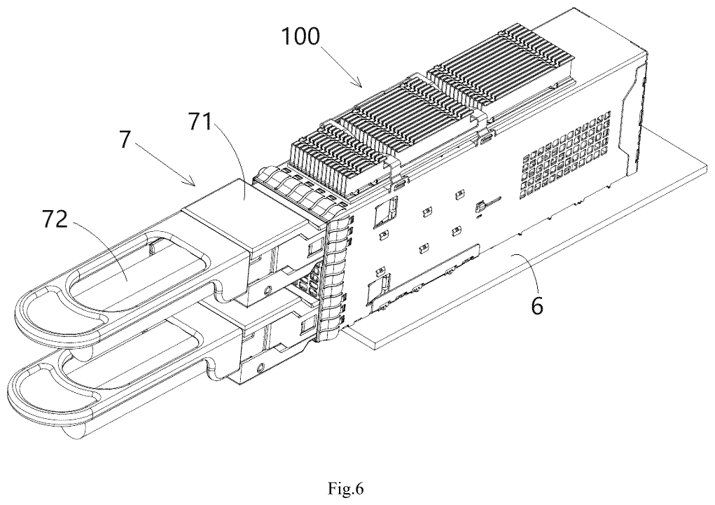

As shown in FIGS. 4 and 5, in the illustrated embodiment, locking spring pieces 11a are formed at the front of a pair of side walls 11, respectively. The locking spring pieces 11a are used to lock the inserted mating connector 7, shown in FIG. 6, in the connector shielding shell 1.

In another exemplary embodiment of the present invention, a connector is also disclosed. The connector includes a connector shielding shell 1 and a terminal module. The terminal module is set in the connector shielding shell 1 and includes an insulator and terminals held in the insulator. One end of the terminal is located in the connector shielding shell 1, used to make electrical contact with a mating terminal of the inserted mating connector 7. The other end of the terminal is exposed from the bottom opening of the connector shielding shell 1 for electrical connection to the circuit board 6.

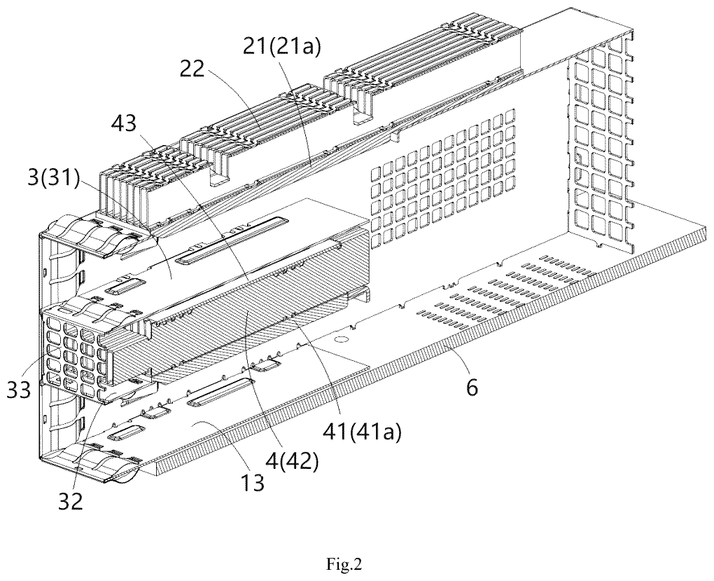

As shown in FIGS. 1 and 2, in the illustrated embodiment, the connector further comprises a partition member 3, which is installed in the connector shielding shell 1 and divides the internal space of the connector shielding shell 1 into two insertion cavities 101 and 102. The connector includes two terminal modules, which are respectively arranged in two insertion cavities 101 and 102, for electrical contact with the mating terminals of two mating connectors 7 inserted into the two insertion cavities 101 and 102, respectively.

As shown in FIGS. 1 and 2, in the illustrated embodiment, the connector further comprises a first heat sink 2, which is mounted on the top wall 12 of the connector shielding shell 1. The first heat sink 2 includes a first base plate 21 and first fins 22. The first base plate 21 is mounted on the top wall 12 of the connector shielding shell 1. The first fin 22 is welded to the top surface of the first base plate 21. On the bottom surface of the first base plate 21, there is a first protrusion 21a, and on the top wall 12 of the connector shielding shell 1, there is a first opening 12a. The first protrusion 21a protrudes into the upper insertion cavity 101 of the connector shielding shell 1 through the first opening 12a to make thermal contact with the mating connector 7 inserted into the upper insertion cavity 101.

As shown in FIG. 1, in the illustrated embodiment, the connector further comprises an elastic clip 23, which is installed on the top wall 12 of the connector shielding shell 1 to apply a predetermined pressing force to the first heat sink 2 to ensure reliable thermal contact between the first heat sink 2 and the mating connector 7 inserted into the upper insertion cavity 101.

As shown in FIGS. 1 and 2, in the illustrated embodiment, the partition member 3 includes a top plate 31, a bottom plate 32, and a front end plate 33 connected between the front ends of the top plate 31 and the bottom plate 32. The top plate 31 of the partition member 3 constitutes the bottom wall of the upper insertion cavity 101 of the connector shielding shell 1, and the bottom plate 32 of the partition member 3 constitutes the top wall of the lower insertion cavity 102 of the connector shielding shell 1. Multiple heat dissipation holes 3b are formed in the front end plate 33 of partition member 3, allowing the internal cavity of partition member 3 to communicate with the external atmosphere, thereby improving the heat dissipation performance of the connector.

As shown in FIG. 2, in the illustrated embodiment, the connector further comprises a second heat sink 4, which is installed in the inner cavity of the partition member 3. The second heat sink 4 includes a second base plate 41 and second fins 42. The second base plate 41 is mounted on the bottom plate 32 of the partition member 3. The second fin 42 is welded to the top surface of the second base plate 41. On the bottom surface of the second base plate 41, there is a second protrusion 41a, and on the bottom plate 32 of the partition member 3, there is a second opening. The second protrusion 41a protrudes into the lower insertion cavity 102 of the connector shielding shell 1 through the second opening to make thermal contact with the mating connector 7 inserted into the lower insertion cavity 102.

As shown in FIG. 2, in the illustrated embodiment, the connector further includes an elastic pressing member 43, which is pressed between the top plate 31 of the partition member 3 and the second fins 42 to apply a predetermined pressing force to the second heat sink 4, ensuring reliable thermal contact between the second heat sink 4 and the mating connector 7 inserted into the lower insertion chamber 102.

As shown in FIG. 1, in the illustrated embodiment, multiple contact spring pieces 3a are formed around the front end plate 33 of the partition member 3, which are used to make electrical contact with a mating shielding shell 71 of the inserted mating connector 7, shown in FIG. 6.

As shown in FIG. 1, in the illustrated embodiment, the connector further comprises an elastic contact component 5, which is installed around the front port of the connector shielding shell 1. The elastic contact component 5 includes outer contact spring pieces 5b and inner contact spring pieces 5a. The outer contact spring pieces 5b are located on the outer side of the connector shielding shell 1, used for electrical contact with the inner side of a mounting port in a mounting panel. The inner contact spring pieces 5a are located on the inner side of the connector shielding shell 1, and are used to make electrical contact with the mating shielding shell 71 of the inserted mating connector 7.

In another exemplary embodiment of the present invention, a connector assembly is also disclosed, as shown in FIGS. 1, 2, and 6. The connector assembly includes a circuit board 6 and the aforementioned connector 100. There are holes formed in the circuit board 6. The connector 100 is installed and electrically connected to the circuit board 6. The plug pins 1a of the connector shielding shell 1 are press fitted into the holes in the circuit board 6, and the terminals of the connector are electrically connected to the circuit board 6. The support portion 10 of the connector shielding shell 1 is pressed against the top surface of the circuit board 6.

As shown in FIGS. 6, 8, and 10, in the illustrated embodiment, the connector assembly further includes a mating connector 7, which is inserted into the front port of the connector shielding shell 1 to mate with the connector 100.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector shielding shell, comprising:
a front port and a rear end wall opposite the front port in a longitudinal direction of the connector shielding shell, a pair of side walls opposite in a transverse direction of the connector shielding shell, and a top wall and a bottom wall opposite in a height direction of the connector shielding shell;
a row of plug pins disposed on a pair of lower side edges of the pair of side walls, the plug pins are press fit into a row of holes in a circuit board to fix the connector shielding shell to the circuit board; and
a support portion that protrudes on the pair of lower side edges of the pair of side walls and/or on the bottom wall, the support portion is located in front of a front most plug pin in the row of plug pins and is spaced apart from the front most plug pin by a predetermined distance in the longitudinal direction, and when a vertical downward external force is applied to a mating connector inserted into the front port of the connector shielding shell, the support portion is pressed against the circuit board as a fulcrum of the connector shielding shell on the circuit board, to increase a force arm and a holding torque of each of the plug pins.

2. The connector shielding shell according to claim 1, wherein the support portion has a pair of support legs on the pair of lower side edges of the pair of side walls, the support legs abut a top surface of the circuit board.

3. The connector shielding shell according to claim 1, wherein the support portion has a support rib on a bottom surface of the bottom wall, the support rib extends along then transverse direction and abuts a top surface of the circuit board.

4. The connector shielding shell according to claim 1, wherein a bottom of the support portion is pressed against a top surface of the circuit board when the connector shielding shell is fixed to the circuit board.

5. The connector shielding shell according to claim 1, wherein the plug pins are further disposed on a lower side edge of the rear end wall, the plug pins on the rear end wall are arranged in a row along the transverse direction and are press fit into a plurality of holes in the circuit board.

6. The connector shielding shell according to claim 1, wherein a plurality of heat dissipation holes are formed in a rear portion of each of the pair of side walls and the rear end wall, an internal space of the connector shielding shell communicates with an external atmosphere through the heat dissipation holes.

7. The connector shielding shell according to claim 1, further comprising:
a main shell portion defining the pair of side walls and the top wall of the connector shielding shell;
a bottom shell portion assembled onto a bottom of the pair of side walls to define the bottom wall of the connector shielding shell; and
a rear shell portion assembled onto a rear end of the pair of side walls to define the rear end wall of the connector shielding shell.

8. The connector shielding shell according to claim 7, wherein each of the main shell portion, the bottom shell portion, and the rear shell portion is an integral stamped piece.

9. The connector shielding shell according to claim 1, wherein a plurality of locking spring pieces are formed at a front of each of the pair of side walls, the locking spring pieces lock the mating connector in the connector shielding shell.

10. A connector, comprising:
a connector shielding shell including:
a front port and a rear end wall opposite the front port in a longitudinal direction of the connector shielding shell, a pair of side walls opposite in a transverse direction of the connector shielding shell, and a top wall and a bottom wall opposite in a height direction of the connector shielding shell;
a row of plug pins disposed on a pair of lower side edges of the pair of side walls, the plug pins are press fit into a row of holes in a circuit board to fix the connector shielding shell to the circuit board; and
a support portion that protrudes on the pair of lower side edges of the pair of side walls and/or on the bottom wall, the support portion is located in front of a front most plug pin in the row of plug pins and is spaced apart from the front most plug pin by a predetermined distance in the longitudinal direction, and when a vertical downward external force is applied to a mating connector inserted into the front port of the connector shielding shell, the support portion is pressed against the circuit board as a fulcrum of the connector shielding shell on the circuit board, to increase a force arm and a holding torque of each of the plug pins; and
a terminal module disposed in the connector shielding shell and having an insulator and a plurality of terminals held in the insulator, a first end of each of the terminals is disposed in the connector shielding shell and electrically contacts a mating terminal of the mating connector, a second end of each of the terminals is exposed from a bottom opening of the connector shielding shell for electrical connection to the circuit board.

11. The connector according to claim 10, further comprising a partition member installed in the connector shielding shell and dividing an internal space of the connector shielding shell into an upper insertion cavity and a lower insertion cavity, the terminal module is one of a pair of terminal modules each arranged in one of the upper insertion cavity and the lower insertion cavity to electrically contact the mating terminal of a pair of mating connectors each inserted into one of the upper insertion cavity and the lower insertion cavity.

12. The connector according to claim 11, further comprising a first heat sink installed on the top wall of the connector shielding shell, the first heat sink includes a first base plate installed on the top wall of the connector shielding shell and a first fin welded to a top surface of the first base plate, a first protrusion is formed on the bottom surface of the first base plate, a first opening is formed in the top wall of the connector shielding shell, the first protrusion protrudes into the upper insertion cavity of the connector shielding shell through the first opening to make thermal contact with the mating connector inserted into the upper insertion cavity.

13. The connector according to claim 12, further comprising an elastic clip installed on the top wall of the connector shielding shell to apply a predetermined pressing force to the first heat sink to ensure reliable thermal contact between the first heat sink and the mating connector inserted into the upper insertion cavity.

14. The connector according to claim 11, wherein the partition member includes a top plate, a bottom plate, and a front end plate connected between a front end of each of the top plate and the bottom plate, the top plate of the partition member constitutes a bottom wall of the upper insertion cavity of the connector shielding shell, and the bottom plate of the partition member constitutes a top wall of the lower insertion cavity of the connector shielding shell, a plurality of heat dissipation holes are formed in a front end plate of the partition member, an inner cavity of the partition member communicates with an external atmosphere through the heat dissipation holes.

15. The connector according to claim 14, further comprising a second heat sink installed in the inner cavity of the partition member, the second heat sink includes a second base plate installed on the bottom plate of the partition member and a second fin welded to a top surface of the second base plate, a second protrusion is formed on a bottom surface of the second base plate, a second opening is formed in the bottom plate of the partition member, the second protrusion protrudes into the lower insertion cavity of the connector shielding shell through the second opening to make thermal contact with the mating connector inserted into the lower insertion cavity.

16. The connector according to claim 15, further comprising an elastic pressing member compressed between the top plate of the partition member and the second fin, the elastic pressing member applies a predetermined pressing force to the second heat sink to ensure reliable thermal contact between the second heat sink and the mating connector inserted into the lower insertion chamber.

17. The connector according to claim 14, wherein a plurality of contact spring pieces are formed around the front end plate of the partition member, the contact spring pieces make electrical contact with a mating shielding shell of the mating connector.

18. The connector according to claim 17, further comprising an elastic contact component installed around the front port of the connector shielding shell, the elastic contact component includes a plurality of outer contact spring pieces located on an outer side of the connector shielding shell and electrically contacting an inner side of a mounting port on a mounting panel, and a plurality of inner contact spring pieces located on an inner side of the connector shielding shell and electrically contacting with the mating shielding shell of the mating connector.

19. A connector assembly, comprising:
a circuit board having a plurality of holes; and
a connector installed and electrically connected to the circuit board, the connector includes:
a connector shielding shell including:
a front port and a rear end wall opposite the front port in a longitudinal direction of the connector shielding shell, a pair of side walls opposite in a transverse direction of the connector shielding shell, and a top wall and a bottom wall opposite in a height direction of the connector shielding shell;
a row of plug pins disposed on a pair of lower side edges of the pair of side walls, the plug pins are press fit into the holes in the circuit board to fix the connector shielding shell to the circuit board; and
a support portion that protrudes on the pair of lower side edges of the pair of side walls and/or on the bottom wall, the support portion is located in front of a front most plug pin in the row of plug pins and is spaced apart from the front most plug pin by a predetermined distance in the longitudinal direction, and when a vertical downward external force is applied to a mating connector inserted into the front port of the connector shielding shell, the support portion is pressed against the circuit board as a fulcrum of the connector shielding shell on the circuit board, to increase a force arm and a holding torque of each of the plug pins; and
a terminal module disposed in the connector shielding shell and having an insulator and a plurality of terminals held in the insulator, a first end of each of the terminals is disposed in the connector shielding shell and electrically contacts a mating terminal of the mating connector, a second end of each of the terminals is exposed from a bottom opening of the connector shielding shell for electrical connection to the circuit board.

20. The connector assembly according to claim 19, further comprising the mating connector inserted into the front port of the connector shielding shell to mate with the connector.
